(19) United States
(12) Patent Application Publication
(10) Pub. No.: US 2016/0303716 A1
(43) Pub. Date: Oct. 20, 2016

(54) Device for Turning an Object

(71) Applicant: Alexei D. Abras, Santa Rosa, CA (US)

(72) Inventor: Alexei D. Abras, Santa Rosa, CA (US)

(21) Appl. No.: 15/133,717

(22) Filed: Apr. 20, 2016

Related U.S. Application Data
(60) Provisional application No. 62/149,951, filed on Apr. 20, 2015.

(51) Int. Cl. B25B 13/52; B67B 7/18

(52) U.S. Cl. CPC B25B 13/52; B67B 7/186

(57) ABSTRACT

A device for turning an object includes a handle defining a cavity and an opening into the cavity, a strap positioned within the cavity and extending through the opening such that an exposed portion of the strap defines a hoop adapted to be place around the object, and a retraction mechanism coupled to the handle and the strap. The retraction mechanism permits more of the strap to be pulled out of the cavity when a force is applied to the exposed portion of the strap. The retraction mechanism also automatically retracts the strap into the cavity when the pulling force is removed. In a particular embodiment, the device is a jar opener. The device provides the advantages that the strap can be easily and securely positioned around an object and enables a person with low grip strength to turn the object.

### CROSS-REFERENCE TO RELATED APPLICATIONS

This application claims the benefit of co-pending U.S. patent application Ser. No. 62/149,951, filed on Apr. 20, 2015 by the same inventor and entitled “Jar Opener”, which is incorporated by reference herein in its entirety.

### BACKGROUND

1. Field of the Invention

The invention relates to devices for gripping and turning objects. Even more particularly the invention relates to a device (e.g., a jar opener, strap wrench, etc.) for turning the lid or cap of a container or the container itself.

2. Description of the Background Art

Devices exist that help turn containers and/or the lids and caps of those containers. Such devices can include a strap that goes around the lid or container. However, such devices are problematic because the strap needs to be tightly pulled and gripped by the user to keep it in position and to prevent it from slipping against the container, cap, or lid during use. This is particularly troublesome for someone suffering from arthritis or any other conditions (e.g., neuropathy, etc.) that prevents him or her from having a strong enough grip to pull and hold the strap. These prior art devices are also problematic because the user may have to fumble with engaging the strap with another part of the device, such as a handle. This too is especially burdensome for those with arthritis or trouble using their hands.

Prior art devices suffer other drawbacks as well. For example, many prior art devices are not able to fit containers and/or lids of various sizes. If a device cannot grip a wide range of containers or lids, its utility and value to the consumer is reduced. While some prior art devices are adjustable, these devices are often very bulky and take up a lot of room to store when not in use.

Yet another drawback of prior art devices is that the strap that engages the lid or container can slide with respect to the lid or container. This problem is exacerbated if the strap stretches, further loosening the grip on the lid.

What is needed, therefore, is a device that can grip a container or lid with sufficient force to turn the container or lid without requiring the user to have a strong grip. What is also needed is a device that can be easily adjusted to grip different sizes of containers and lids. What is also needed is a device that is compact for storage. What is also needed is a device that obtains an effective grip on the container of lid.

### SUMMARY

The invention overcomes the problems associated with the prior art by providing a device (e.g., a jar opener, strap wrench, etc.) that includes a self-retracting strap that can be quickly and easily secured around an object (e.g., ajar, a lid, etc.). The strap self-retracts into a handle of the jar opener until the strap is securely positioned around the object. When the strap is retracted and the user applies force to move the handle in the turn direction, the handle locks the strap in place against the handle and around the object and causes the object to turn. The user does not need to hold a loose end of a strap tightly or in a particular position while turning, which is particularly beneficial to those will low grip strength and/or muscular-skeletal pain. Thus, the jar opener quickly and easily engages the object and enables the user to rotate the object.

The strap is made of a material that is resistant to stretching (e.g., spring steel) and includes a layer of material (e.g., rubber) that increases friction between the strap and the engaged object.

The inventive jar opener also enables unscrewing and screwing of caps, lids, and other threaded and rotatable objects of various diameters. In a particular embodiment of the invention, the jar opener can turn objects having diameters from approximately 0.25 inches to greater than 6 inches. While the device of the present invention is especially well-suited to opening and closing rotatable caps, lids, and other objects that are round in shape, it can readily accommodate objects of various shapes (e.g., oval, rectangular, etc.).

A device for turning an object according to the present invention includes a handle defining a cavity and an opening into the cavity, a strap disposed partially within the cavity and extending through the opening such that an exposed portion of the strap defines a hoop adapted to be placed around the object, and a retraction mechanism coupled to the handle and the strap. The retraction mechanism is configured to permit more of the strap to be pulled out of the cavity when a force is applied to the exposed portion of the strap as well as to automatically retract the strap into the cavity when the force is removed. In other words, the invention provides a device that includes a means for releasing more of the strap from the cavity responsive to a pulling force applied to the strap and for automatically retracting the strap into the cavity when the pulling force is removed. Optionally, the handle includes a strap guide adapted to guide the strap as the strap moves through the opening.

In one embodiment, the retraction mechanism comprises a retraction coil (e.g., a flat torsion spring), which can optionally be integrally formed with the strap. If integrally formed, a. first end of the strap can be secured to the handle at a first location (optionally within the cavity of the handle) and a second end of the strap can be secured to the handle at a second location, where the second location is within the cavity. The retraction coil can be formed near the second end of the strap, and the second end of the strap can be disposed within a slot of a strap anchor that is coupled to the handle near the second location. In a more particular embodiment, the retraction coil is disposed around the strap anchor.

According to another embodiment, the strap is formed from spring steel. The strap can also include a friction material applied to it, such as rubber, to increase friction between the strap and the object and/or between the strap and the handle. Optionally, the friction material can be applied to some, but not all, of the strap.

According to still another embodiment, the handle includes a pivot adjacent to the opening. The pivot is adapted to press against the strap when the hoop is placed around the object and the handle is rotated. The pivot is also adapted to take up slack in the strap and increase a compressive force about the object when the hoop is placed around the object and the handle is rotated. In a particular embodiment, the pivot further includes a friction material for contacting the strap. Optionally, the strap can include a friction material on its outer surface that contacts the pivot.

### BRIEF DESCRIPTION OF THE DRAWINGS

The present invention is described with reference to the following drawings, wherein like reference numbers denote substantially similar elements:

FIG. 1 is a perspective view of one embodiment of a device for turning an object according to the present invention;

FIG. 2 is a perspective view showing the device of FIG. 1 having part of its handle casing removed;

FIG. 3 is a perspective view showing the device of FIG. 1 opening a container with an out-of-round lid; and

FIG. 4 is a perspective view showing the device of FIG. 1 opening a container with a round lid.

FIG. 5 is a perspective view showing the device of FIG. 1 turning an oil filter.

### DETAILED DESCRIPTION

The present invention overcomes the problems associated with the prior art, by providing a device (e.g., a jar opener, a strap wrench, etc.) for unscrewing or screwing lids or caps from containers, jars, bottles, and other similar objects containing screw or twist type parts. The device of the invention is especially useful for people with low grip strength, with arthritic conditions where pain prevents them from being able to open and close screw-type components, and for people trying to avoid overstressing the hand and wrist joints. In the following description, numerous specific details are set forth (e.g., ergonomic features, etc.) in order to provide a thorough understanding of the invention. Those skilled in the art will recognize, however, that the invention may be practiced apart from these specific details. In other instances, details of well-known practices (e.g., routine optimization, routine manufacturing, etc.) and components have been omitted, so as not to unnecessarily obscure the present invention.

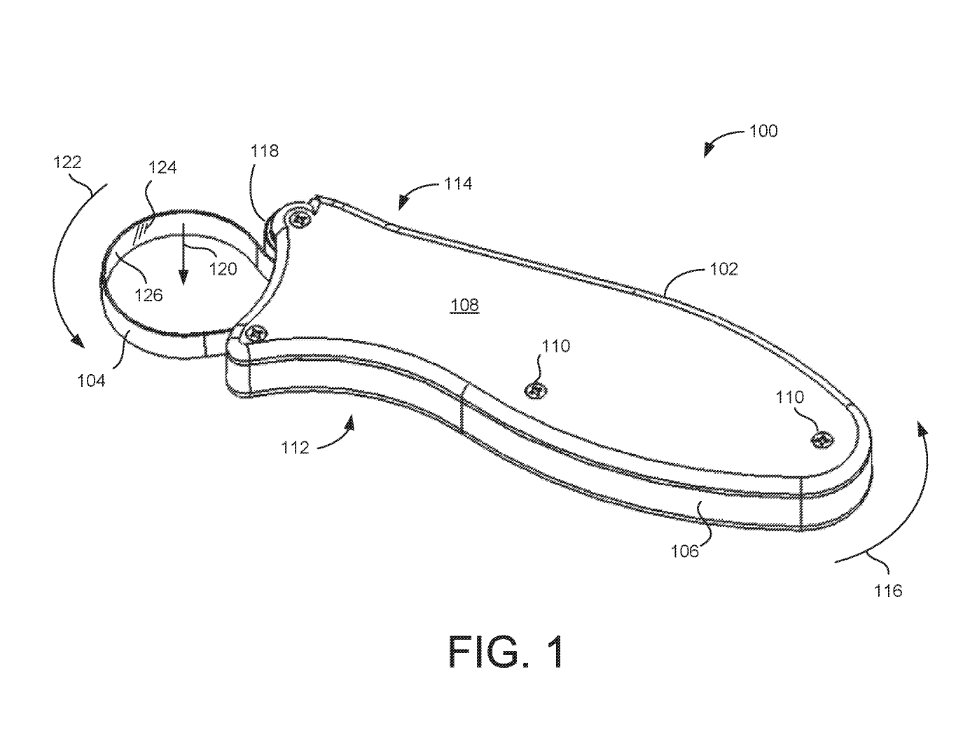

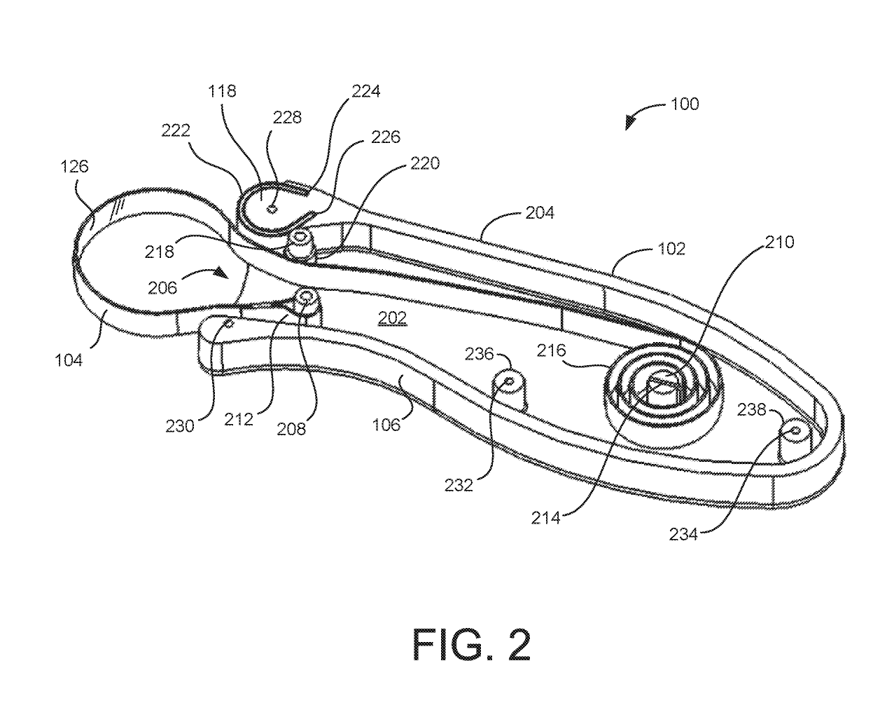

FIG. 1 shows a device 100 for turning objects according to one embodiment of the present invention. Hereinafter, device 100 will be described as a jar opener 100. However, other characterizations of device 100, such as strap wrench, are also appropriate. Jar opener 100 includes a handle 102 and a strap 104. Handle 102 includes a case 106 and a cover 108 that is fixed to the case 106 by a plurality of fasteners 110 (e.g., screws, rivets, etc.). Handle 102 includes a hollow interior (FIG. 2) so that strap 104 can be retracted and contained therein.

Handle 102 functions to apply a rotational force to an object (not shown) via strap 104. Handle 102 is contoured to comfortably and securely fit within a user's hand. In particular, handle 102 includes a larger contour 112 that receives the user's fingers and a smaller contour 114 that receives a portion of the hand between the base of the thumb and index finger. The top of the cover 108 is fiat to engage the palm of the hand. When a user grips the handle 102 and rotates it in the direction of the arrow 116, a pivot 118 of the handle 102 acts as a fulcrum against the strap 104 and object. This action tightens the strap 104 around the object and applies both a radially-inward (compressive) force 120 to the object and a rotational force to the object in the direction of the arrow 122.

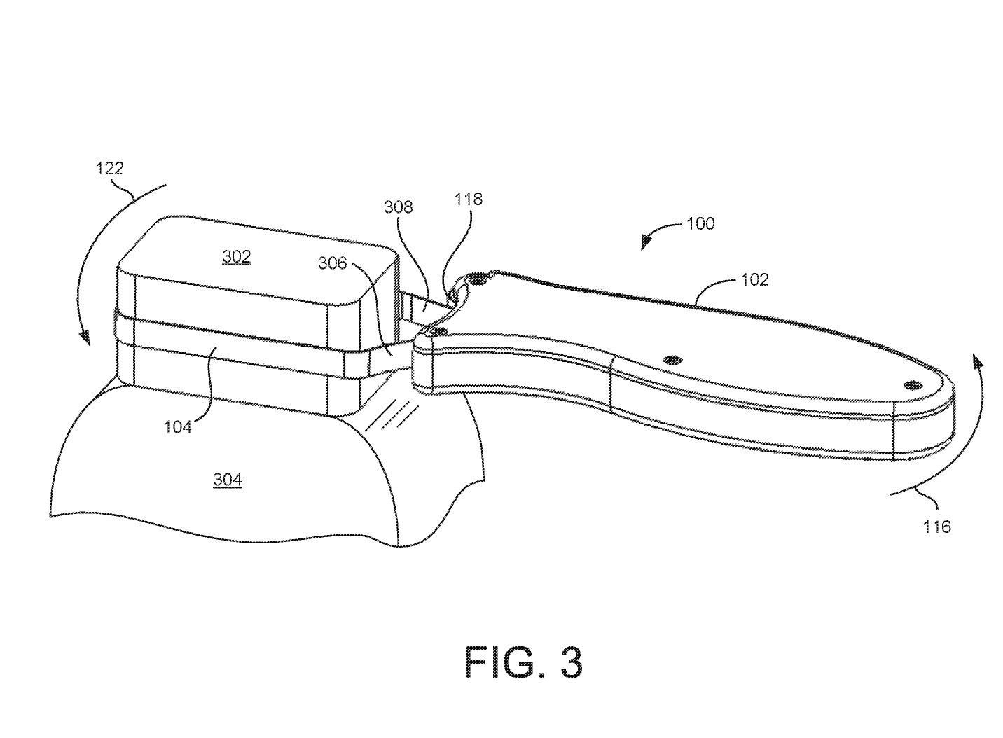

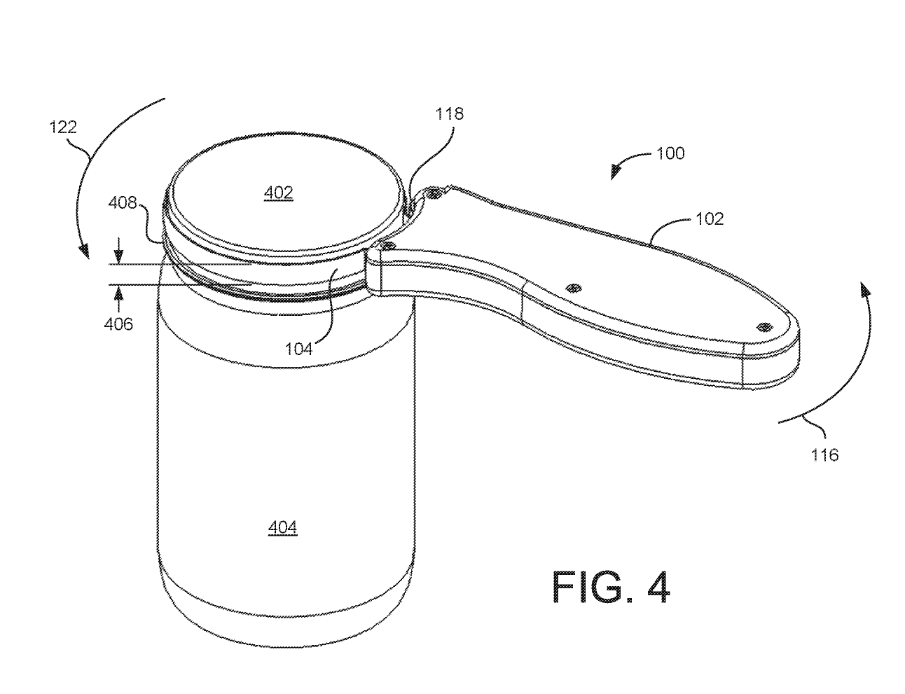

Strap 104 is a long band and, in the present embodiment, is formed from spring steel. At least some of strap 104 is also coated in a high-friction material 124, such as rubber, to improve friction between strap 104 and the object being turned and/or between strap 104 and pivot 118. Most of strap 104 is housed within a cavity in handle 102 (FIG. 2) when jar opener 100 is not in use. Strap 104 is lengthened by pulling more of strap 104 out of handle 102. Strap 104 also automatically self-retracts into handle 102 when the pulling force is released from the exposed portion 126 of strap 104. This automatic retraction causes strap 104 to readily engage an object placed within the hoop defined by the exposed portion 126 of strap 104. (See also FIGS. 3 and 4).

FIG. 2 shows jar opener 100 with cover 108 removed from case 106 to show the interior cavity of handle 102 and strap 104 in greater detail. As shown, case 106 defines a cavity within handle 102. In the present embodiment case 106 and cover 108 are formed (e.g., molded) from a plastic material. However, they can be formed by other manufacturing methods (e.g., stamping, milling, etc.) and material (e.g., metal) if desired.

Case 106 includes a base 202 and a sidewall 204 extending vertically from base 202. Sidewall 204 defines an opening 206 through which strap 104 is positioned. Case 106 also includes a first strap anchor 208 and a second strap anchor 210. A first end of strap 104 includes a loop 212 that is positioned around first strap anchor 208, and a second end of strap 104 is positioned in a slot 214 of second strap anchor 210. A portion of strap 104 near its second end is further formed into a retraction coil 216 around second strap anchor 210. First and second strap anchors 208 and 210 can be reinforced by fasteners (e.g., screws, rivets, etc.) through the bottom 202 of case 106. Additionally, bottom 202 can be optionally attached to sidewall 205 as a separate component, similar to cover 108. Cover 108 retains strap 104 in position on anchors 208 and 210.

Because strap 104 is formed from spring steel, the portion of strap 104 formed into retraction coil 216 functions as a flat torsion spring. In particular, retraction coil 216 enables strap 104 to be pulled out of handle 102 to lengthen the exposed portion 126 of strap 104, because retraction coil 216 will deform (tighten) around strap anchor 210 to provide extra strap length. Retraction coil 216 also causes strap 104 to self-retract into handle 102 when the user releases the exposed portion 126 of strap 104, because retraction coil 216 will expand and return to its static spiral position, thereby removing the slack in strap 104. Thus, retraction coil 216 is a means for releasing more of the strap from the cavity responsive to a pulling force being applied to the strap and a means for automatically retracting the strap into the cavity when the pulling force is removed.

In a particular embodiment, the high-friction material 124 is not applied to the portion of strap 104 that forms retraction coil 216 to prevent binding of the retraction coil 216. Additionally, the length of strap 104 is selected such that, in its fully retracted state, at least some of strap 104 remains exposed outside of handle 102 to enable to a user to pull on strap 104. In the present embodiment, the retraction mechanism (retraction coil 216) is an integral part of strap 104. However, other retraction mechanisms (e.g., one or more springs) can be used as an alternative or in addition to retraction coil 216. As another example, retraction coil 216 can be a separate component attached (e.g., glued, welded, etc.) to strap 104.

Handle 102 is also shown to include a guide 218 located near pivot 118. Guide 218 guides the movement of strap 104 as strap 104 is withdrawn from and retracted into cavity 202 of handle 102. To help achieve this function, guide 218 can include a roller 220 that rotates about guide 218 as strap 104 moves past it. Optionally, some other low-friction bearing could be substituted for roller 220.

Pivot 118 of handle 102 is also shown in greater detail in FIG. 2. In the current embodiment, pivot 118 is formed integrally with sidewall 204 of case 106 and has a high-friction member 222 applied to its outer surface. High-friction member 222 provides friction against the strap 104 to prevent the strap 104 from slipping relative to the handle 102 during a turning operation. The high-friction member 222 can be made of rubber and can be applied to pivot 118 during the fabrication of handle 102 or can be attached (e.g., glued) to pivot 118 as a separate component at a later time. In the embodiment shown, high-friction member 222 is a rubber insert that is glued about pivot 118 and has its distal ends fitted within grooves 224 and 226 formed in case 106. While rubber is provided as an example of high-friction material for pivot 118 and material 124, other suitable friction-increasing materials can be used.

Once the strap 104 is attached within handle 102, cover 108 can be attached to case 106 using fasteners 110. As shown in FIG. 2, apertures 228-234 receive the fasteners 110. Apertures 228 and 230 are defined by sidewall 204, whereas apertures 232 and 234 are defined by respective risers 236 and 238. In this embodiment, risers 236 and 238 are integrally formed with case 106. Apertures 228-234, sidewall 204, and risers 236-238 function as anchor points for fasteners 110 as well as improve the structural rigidity of handle 102.

FIG. 3 is a perspective view showing jar opener 100 being used to remove a twist-on lid 302 of a jar 304. Strap 104 has been pulled from the cavity within handle 102 by a user, placed around lid 302, and self-retracted such that handle 102 is located near lid 302. Turning the handle 102 in the direction 116 initially takes up the slack 306 and 308 in strap 104, tightens strap 104 around lid 302, and moves pivot 118 into position against lid 302. Continued movement of handle 102 in the direction of arrow 116 applies rotational force to lid 302 via strap 104, causing lid 302 to rotate in the direction of arrow 122 and open the container 304. Notably, the flexible strap 104 is able to securely engage the out-of-round lid 302, because the strap 104 squeezes the lid 302 as handle 102 is turned.

FIG. 4 is another perspective view showing jar opener 100 being used to remove a twist-on lid 402 of a jar 404. In FIG. 4, however, the lid 402 is round. Like before, turning the handle 102 in the direction 116 takes up residual slack in strap 104, tightens strap 104 around lid 402, and presses pivot 118 against lid 402. Continued movement of handle 102 in the direction of arrow 116 causes lid 402 to rotate in the direction of arrow 122 and opens the container 404. FIG, 4 also shows that, because strap 104 is made from a strong material that resists stretching, in this case spring steel, strap 104 can be made shorter in a height direction 406 if desired. Accordingly, strap 104 can often be positioned to avoid irregular physical features of the objects that it placed around, such as a lower lip 408 of lid 402.

Jar opener 100 has been described in the prior figures as providing a counter-clockwise turning force to lids 302 and 402 in the direction of arrow 122, which opens the containers 304 and 404, respectively. It should be noted, however, that jar opener 100 can also be used to tighten lids 302 and 402 by turning jar opener 100 over, engaging the lid 302 or 402 in the hoop of the strap 104, and turning handle 102 in a direction opposite to the direction of arrow 116 (clockwise). Thus, device 100 can be used to loosen and/or tighten the lids 302 and 402 as desired by the user. This is especially advantageous to someone with low grip strength or hand pain who might find screwing a lid back on an open container difficult.

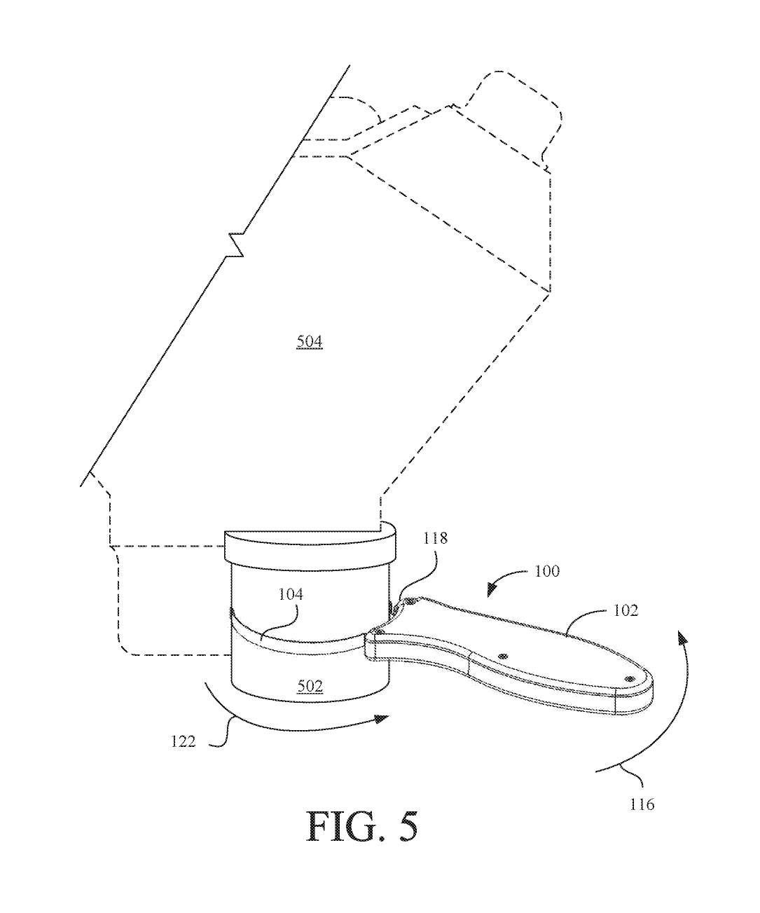

In addition to opening jars, device 100 can be used to turn other objects as well. For example, FIG. 5 is a perspective view showing device 100 being used to unscrew an engine oil filter 502 from an engine block 504. As in prior figures, turning the handle 102 in the direction 116 takes up residual slack in strap 104, tightens strap 104 around oil filter 502, presses pivot 118 against oil filter 502, and applies a rotational force in the direction of arrow 122 sufficient to unscrew oil filter 502 from engine block 504, Thus, device 100 has a wide variety of everyday uses.

The device of the present invention provides several important advantages, including:
(1) A strap that is self-retracting to automatically accommodate lids, caps, and any other similar object of various diameters. The self-retracting action avoids having to manually tighten and secure the strap around the object to be unscrewed or screwed. Additionally, the retraction mechanism can be integrated with the strap, for example, as a torsion coil spring.
(2) A strap that is made of a material that can handle the high tension loads resulting from the unscrewing or screwing action without stretching and yet is flexible and has a rubberized surface to provide adequate friction between the strap and the object being unscrewed or screwed. These attributes allow most or all of the force being applied by the user to be transmitted into unscrewing or screwing the object without stretching or slipping the strap. In a. particular embodiment, the strap is made of spring steel and at least some of it coated with a high-friction material (e.g., rubber).
(3) The strap is flexible enough to conform to very small caps such as from toothpaste tubes and the like and can conform around shapes that may not necessarily be round. In a particular embodiment of the invention, the device can turn objects having diameters from approximately 0.25 inches to greater than 6 inches. The description of particular embodiments of the present invention is now complete. Many of the described features may be substituted, altered or omitted without departing from the scope of the invention. For example, the invention is not limited to the types of containers described herein, but could be used to turn other types of rotatable and/or threaded objects, such as fuel filters, valves, connectors, etc. As another example, the handle of the jar opener could be made according to other ergonomic designs. These and other deviations from the particular embodiments shown will be apparent to those skilled in the art, particularly in view of the foregoing disclosure.

I claim:

1. A device for turning an object, said device comprising:
a handle defining a cavity and an opening into said cavity;
a strap disposed partially within said cavity and extending through said opening such that an exposed portion of said strap defines a hoop adapted to be placed around said object; and
a retraction mechanism coupled to said handle and said strap; and wherein
said retraction mechanism is configured to permit more of said strap to be pulled out of said cavity when a force is applied to said exposed portion of said strap; and
said retraction mechanism is further configured to automatically retract said strap into said cavity when said force is removed.

2. The device of claim 1, wherein said retraction mechanism comprises a retraction coil.

3. The device of claim 2, wherein said retraction coil is formed integrally with said strap.

4. The device of claim 3, wherein:
a first end of said strap is secured to said handle at a first location; and
a second end of said strap is secured to said handle at a second location, said second location being within said cavity.

5. The device of claim 4, wherein said retraction coil is formed near said second end of said strap.

6. The device of claim 5, further comprising:
a strap anchor coupled to said handle near said second location; and wherein
said strap anchor defines a slot to receive said second end of said strap therein.

7. The device of claim 6, wherein said retraction coil is disposed around said strap anchor.

8. The device of claim 4, wherein said first end of said strap is secured to said handle within said cavity.

9. The device of claim 2, wherein said retraction coil comprises a flat torsion spring.

10. The device of claim 1, wherein said strap is formed from spring steel.

11. The device of claim 1, wherein said strap includes a friction material applied thereto.

12. The device of claim 11, wherein said friction material comprises rubber.

13. The device of claim 11, wherein said friction material is applied to some, but not all, of said strap.

14. The device of claim 1, wherein said handle includes a pivot adjacent to said opening.

15. The device of claim 14, wherein said pivot is adapted to press against said strap when said hoop is placed around said object and said handle is rotated.

16. The device of claim 15, wherein said pivot is further adapted to take up slack in said strap and increase a compressive force on said object when said hoop is placed around said object and said handle is rotated.

17. The device of claim 14, wherein said pivot further comprises a friction material applied thereto.

18. The device of claim 14, wherein said strap includes a friction material applied on an outer surface of said strap configured to contact said pivot.

19. The device of claim 1, wherein said handle includes a strap guide adapted to guide said strap as said strap moves through said opening.

20. A device for turning an object, said device comprising:
a handle defining a cavity and an opening into said cavity;
a strap disposed partially within said cavity and extending through said opening such that an exposed portion of said strap defines a hoop adapted to be placed around said object; and
means for releasing more of said strap from said cavity responsive to a pulling force applied to said strap and for automatically retracting said strap into said cavity when said pulling force is removed.
